(19) United States
(12) Patent Application Publication
(10) Pub. No.: US 2005/0221682 A1
(43) Pub. Date: Oct. 6, 2005

(54) High speed receptacle connector part

(75) Inventor: Stuart Craig Stoner, Lewisberry, PA (US)

Correspondence Address: WOODCOCK WASHBURN, LLP, ONE LIBERTY PLACE - 46TH FLOOR, PHILADELPHIA, PA, 19103, US

(73) Assignee: FCI Americas Technology, Inc., Reno, NV (US)

(21) Appl. No.: 11/070,313

(22) Filed: Mar. 2, 2005

Related U.S. Application Data
(60) Provisional application No. 60/559,891, filed on Apr. 6, 2004.

(51) Int. Cl. H01R 13/648

(52) U.S. Cl. 439/689

(57) ABSTRACT

In an electrical connector, one or more contacts may be inserted into a base housing. The contacts A may be stamped from a sheet of electrically conductive material. A housing cover may be assembled onto the base housing. The base housing and housing cover may be molded from an electrically insulating material. A structure may be provided for retaining the contacts in the housing. Angled surfaces on the cover come into contact with lead-in surfaces on beams of the contacts. Downward motion of the cover towards the base cams the contact beams outward to a specified distance, thus creating a preload situation of the contact beams against the surfaces. The contacts may be bifurcated or single beam contacts.

### CROSS-REFERENCE TO RELATED APPLICATIONS

This application claims benefit under 35 U.S.C. § 119(e) of provisional U.S. patent application No. 60/559,891, filed Apr. 6, 2004.

This application is related to U.S. patent application Ser. No. 10/318,814, filed Apr. 6, 2004.

The contents of each of the above-referenced U.S. patent applications is incorporated herein by reference.

### FIELD OF THE INVENTION

The invention relates in general to electrical connectors. More particularly, the invention relates to a high speed receptacle connector part.

### BACKGROUND OF THE INVENTION

As the speed of electronics increases, electrical connectors are desired that are capable of high speed communications. Electrical connectors provide signal connections between electronic devices using signal contacts. With electronic device miniaturization and high speed electronic communications becoming more prevalent, the signal contacts will be very closely spaced. Often, the signal contacts are so closely spaced that signal integrity becomes a problem.

One method for improving signal integrity is removing the plastic material in the contact area of the contacts. In this manner air will be the main dielectric in the contact area of the contacts. However reducing plastic material in the contact area of a connector part poses problems regarding positioning and supporting of the contact portions of the signal contacts. Therefore, a need exists for a high speed electrical connector design that reduces the plastic material while maintaining a guaranteed support of the contact portions of the signal contacts.

### SUMMARY OF THE INVENTION

The invention provides an electrical connector having a base housing and an electrical contact inserted into the base housing. The contact may have a contact beam with a lead-in surface for receiving an angled surface of a housing cover. The contact may be retained in the base housing. The housing cover may be assembled onto the base housing. The contact beam may be adapted to move a specified distance to preload the contact beam against an angled surface of the housing cover.

The receptacle contact may have a pair of contact beams, with each contact beam having a lead-in surface for receiving a respective angled surface of the housing cover. The angled surfaces may cause the contact beams to move apart by a predetermined distance in response to movement of the cover toward the base housing. The housing cover may form an aperture extending therethrough for receiving a complementary electrical contact into the receptacle contact. The aperture may be formed between the angled surfaces.

The base housing and cover may be molded from an electrically insulating material. The contact may be a bifurcated dual-beam contact, or it may include a pair of single beams. The contact may be stamped from a sheet of electrically conductive material.

### BRIEF DESCRIPTION OF THE DRAWINGS

The invention will be further explained by reference to the drawings showing an illustrative embodiment of the receptacle connector part according to the invention.

FIG. 1 is a top view of the back side of the connector housing of an exemplary embodiment of the receptacle connector part in accordance with the invention.

FIG. 2 is a cross-section of the connector housing according to the line II-II in FIG. 1.

FIG. 3 is a perspective view of the connector housing of FIG. 1.

FIGS. 4A and 4B show top and side views of a row of receptacle contact terminals to be mounted in the connector housing of FIG. 1.

FIG. 5 shows a cross-section of the connector housing of FIG. 1 during the assembly step of inserting a row of receptacle contact terminals.

FIG. 6 shows a cross-section corresponding to FIG. 5, wherein the contact portion of the receptacle contact terminals is meeting the preload ridges.

FIG. 7 shows a cross-section corresponding to FIG. 5, wherein the row of receptacle contact terminals is further inserted into the housing.

FIG. 8 shows a cross-section corresponding to FIG. 5, wherein the row of receptacle contact terminals is fully inserted into the connector housing.

FIG. 9 shows a cross-section corresponding to FIG. 8, wherein the contact portions of the contact terminals are shown in a position as if a plug signal or ground contact has been inserted.

FIG. 10 is a perspective view of the connector housing.

FIGS. 11A and 11B depict example embodiments of an electrical connector according to the invention.

### DETAILED DESCRIPTION OF ILLUSTRATIVE EMBODIMENTS

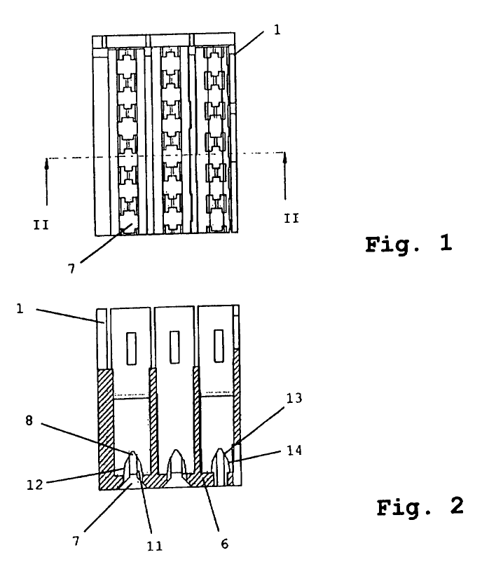

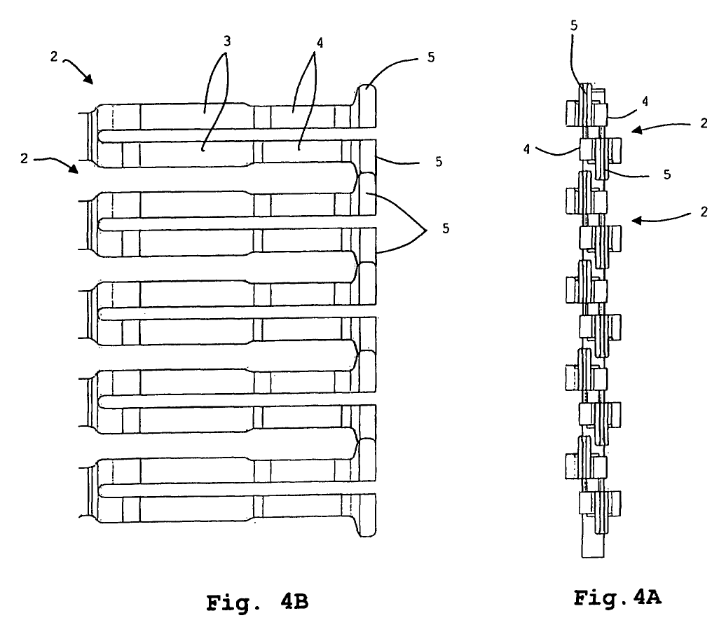

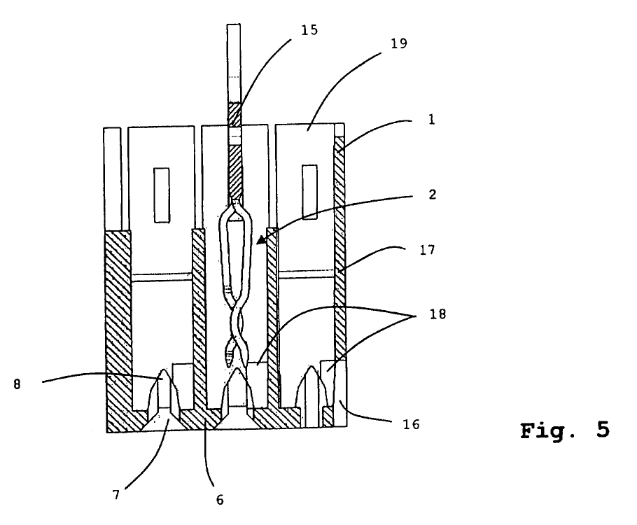

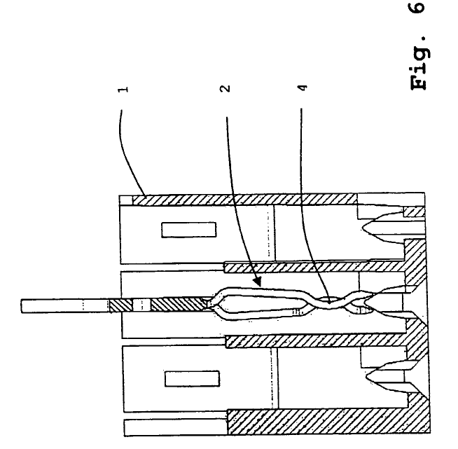

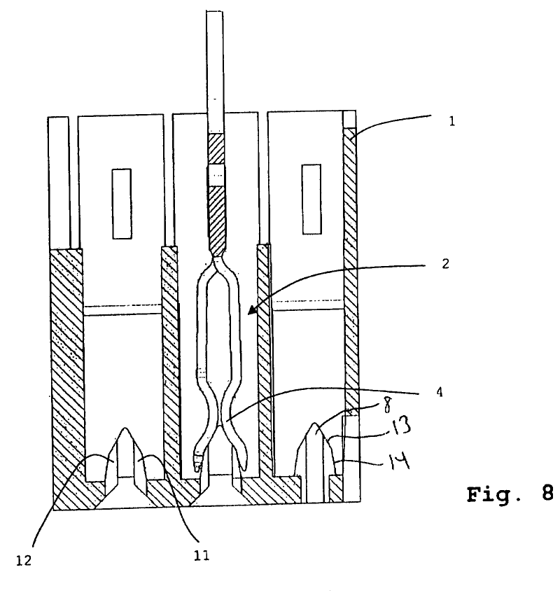

Referring to the drawings there is shown an embodiment of the receptacle connector part according to the invention, comprising a connector housing 1 shown in FIGS. 1-3, and a plurality of rows of receptacle contact terminals 2 shown in FIGS. 4A and 4B. FIGS. 5-8 show a cross section of the connector housing 1 with one row of contact terminals 2 during an assembly step of inserting the contact terminals 2 into the housing 1. In the drawings the connector housing 1 is shown open at one side for explanation purposes only. Normally, a side wall will be present.

Each receptacle contact terminal 2 includes two single beam contacts 3 having a contact portion 4 with a preload head 5 at its contact tip. As can be seen in the side view of the row of contact terminals 2 in FIG. 4B the contact portions have a kind of hammer head shape, wherein the preload heads 5 of the single beam contacts of one contact terminal 2 extend in opposite directions along the row direction.

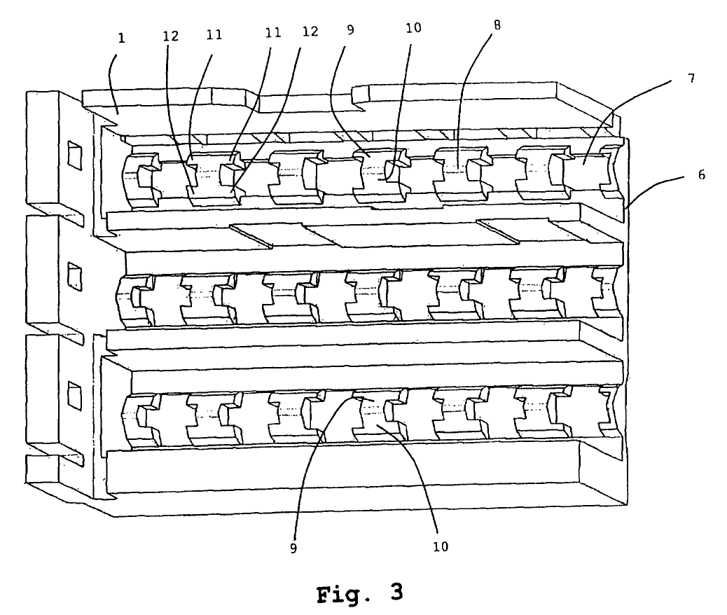

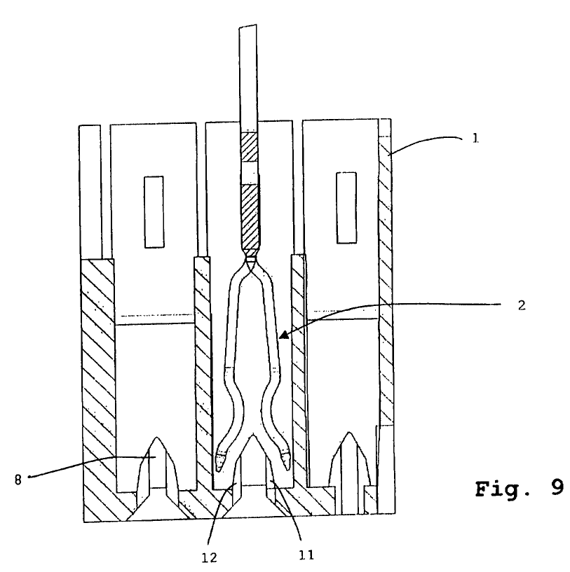

The connector housing 1 comprises a front wall 6 with a plurality of rows of apertures 7, which apertures 7 provide access to the contact portions 4 of the contact terminals 2. Further, the connector housing 1 is provided with a plurality of rows of preload ridges 8 located at the inner side of the front wall 6 at opposed sides of the apertures 7. As will be explained hereinafter the preload ridges 8 cooperate with the preload heads 5 to support the contact portions 4 of the single beam contacts 2 of each contact terminal 2 in a predetermined preload position shown in FIG. 8. In the embodiment shown in the drawings one V-shaped preload ridge 8 is located in between each two adjacent apertures 7. The tip of the V-shaped ridges 8 is directed away from the apertures 7. In this manner, each V-shaped ridge 8 shows two ramp surfaces 9 and 10 extending in a lateral and downward direction from the centre line of a row of apertures 7 to one side of the row of apertures. It is noted that lateral direction means transverse to the row direction and downwards means from the upper to the lower side of the views as shown in FIGS. 2 and 8.

Although in the embodiment shown one V-shaped preload ridge 8 is located in between each two adjacent apertures 7, it will be clear that different embodiments and shapes of pre-load ridges are possible providing ramp surfaces 9, 10 extending in the same manner in a lateral and downward direction. For example, separated V-shaped ridges could be provided, each having ramp surfaces 9, 10. Such V-shaped ridges 8 can be seen at the upper and lower sides of the top view of FIG. 1. As a further alternative separated preload ridges could be provided, one preload ridge having the ramp surface 9 and the other preload ridge having the ramp surface 10. In the latter case the ramp surfaces 9, 10 could extend along the full transverse dimension of the apertures 7.

Preferably, the V-shaped preload ridges 8 are provided with four support extensions 11, 12, each two support extensions 11, 12 extending in row direction along opposed sides in an aperture 7. In this manner, each aperture 7 is bounded by four support extensions 11, 12 directed towards each other at opposed sides of the aperture.

In the embodiment shown in the drawings, the ramp surfaces 9, 10 of the V-shaped preload ridges have first and second sections 13, 14, extending downwardly at different angles. As can be seen in the cross-sections of FIGS. 2 and 8, for example, the second section 14 extends more steeply downwardly as the first section 13.

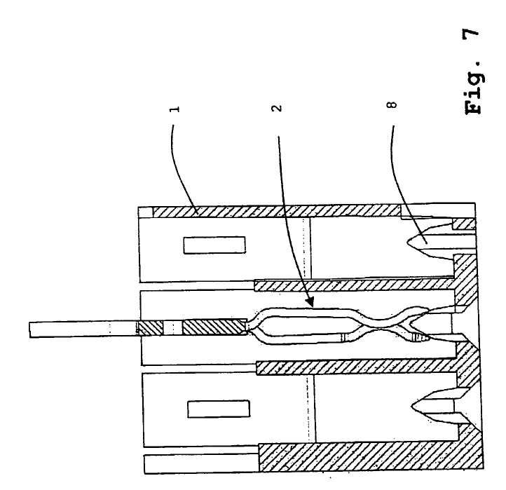

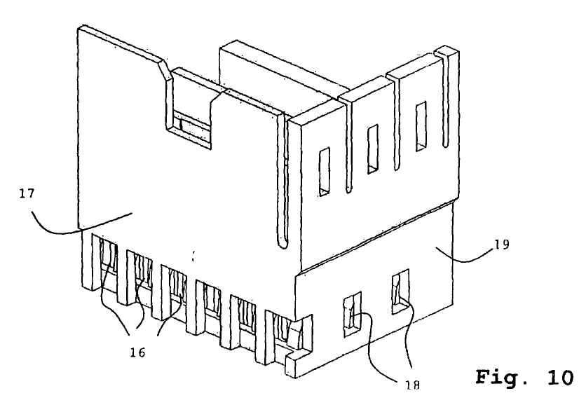

FIGS. 5-8 show subsequent phases of the assembly of the receptacle connector part as described, during which assembly the rows of contact terminals 2 are inserted into the connector housing 1. In the cross-section of FIG. 5 a centre row of contact terminals 2 is in a first phase of the insertion process. It is noted that a row of contact terminals can be provided as an assembly as described in U.S. Pat. No. 6,652,318, wherein the terminals are interconnected by a holder 15 of insulating material. The contact portions 4 are slightly open at the contact tip, so that the tip of the V-shaped ridges 8 can be received in between the contact portions 4. In the cross-section of FIG. 6, the preload heads 5 of the contact portions 4 are meeting with the first sections 13 of the ramp surfaces 9, 10 of the V-shapes ridges 8 at both sides of the corresponding apertures 7. During the further insertion of the row of contact terminals 2 into the connector housing 1, the contact portions 4 are further opened as the preload heads 5 move further downwards along the ramp surfaces 9, 10. In the last part of the insertion process, the preload heads 5 of the contact portions 4 will be received on the support extensions 11 of the V-shaped ridges 8 as shown in particular in FIG. 8. FIG. 9 shows a cross section of the connector housing 1 as in FIG. 8, wherein the contact portions 4 are moved outwardly as if a contact pin has been inserted through the corresponding aperture 7. In this contacting position the preload heads 5 are lifted off from the support extensions 11, 12.

In the final position of the contact terminals 2 as shown in FIG. 8, the contact portions 4 are accurately supported with a guaranteed preload, wherein the contact area of the contact portions 4 is fully free of any plastic material. In this manner the signal integrity performance of the contact terminals 2 is improved. Moreover, the design of the V-shaped preload ridges 8 with the support extensions 11, 12 extending along the sides of the apertures 7 in row direction, guarantees a reliable support of the contact portions 4 in the pre-load position within the full range of manufacturing tolerances of all parts of the receptacle connector part.

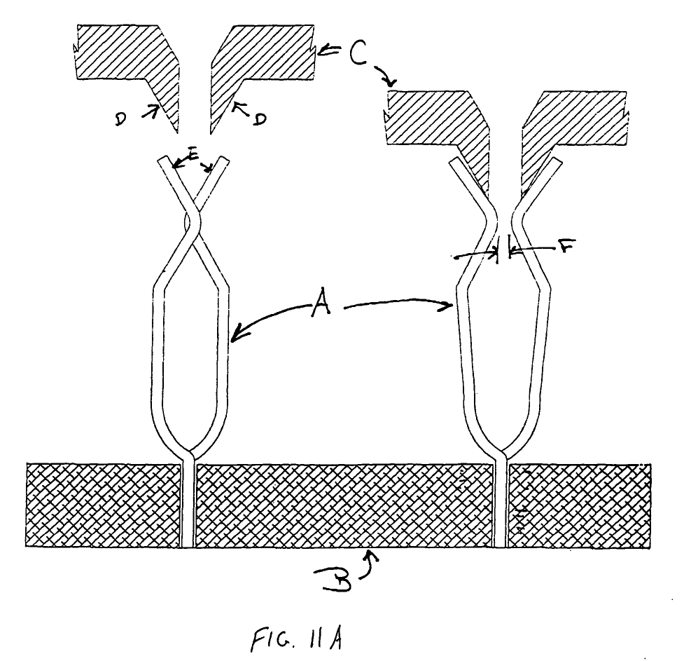

In the embodiment of the receptacle connector part shown, any interference of the contact portions, in particular the contact tip parts thereof, is avoided by providing windows 16 in the sidewall 17 of the connector housing 1. These windows 16 receive the contact portion of the terminals 2 of the adjacent row of receptacle contact terminals. In the same manner windows 18 are provided in the lateral sidewalls 19 of the connector housing 1, only one of which is shown in the drawings. FIG. 10 illustrates the presence of the windows 16 in the sidewall 17 and the windows 18 in the lateral sidewall 19.

Preloading of contact beams provides for a known or consistent normal force and decreased mating force. The invention provides methods for providing preloading of contact beams in an electrical connector. Though the invention is been described in terms of a “receptacle” connector, it should be understood that the principles of the invention may be applied to other types of connectors, such as reverse gender connectors, for example.

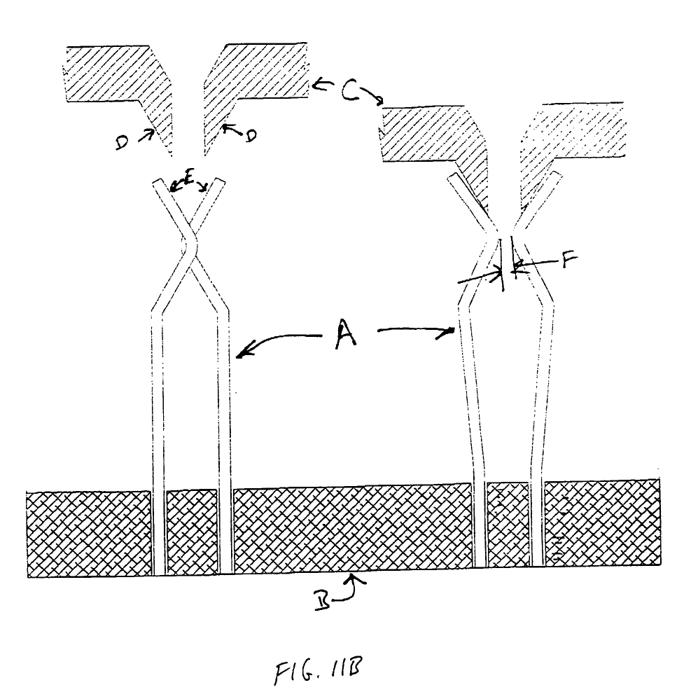

FIGS. 11A and 11B depict example embodiments of an electrical connector according to the invention. As shown, one or more contacts A may be inserted into a base housing B. The contacts A may be stamped, for example, from a sheet of electrically conductive material, such as a metal. A housing cover C may be assembled onto the base housing B. The base housing B and housing cover C may be molded, for example, from an electrically insulating material, such as a plastic. It should be understood that any structure may be provided for retaining the contacts A in the base housing B.

Respective angled surfaces D on the cover C come into contact with lead-in surfaces E on the beams of the contacts A. Downward motion of the cover C towards the base B causes the contact beams to move outward to a predetermined distance F between them, thus creating a preload situation of the contact beams against the surfaces D. The contacts C may be bifurcated contacts, as shown in FIG. 11A, or single beam contacts, as shown in FIG. 11B.

It is to be understood that the foregoing illustrative embodiments have been provided merely for the purpose of explanation and are in no way to be construed as limiting of the invention. The invention extends to all functionally equivalent structures, such as are within the scope of the appended claims.

1. An electrical connector comprising:
a base housing;
a housing cover assembled onto the base housing;
a receptacle contact inserted into the base housing, said contact having a pair of contact beams, each said contact beam having a lead-in surface for receiving an angled surface of the housing cover,
wherein angled surfaces cause the contact beams to move apart by a predetermined distance in response to movement of the cover toward the base housing.

2. The electrical connector of claim 1, angled surfaces cause the contact beams to move apart to preload the contact beams against the angled surfaces.

3. The electrical connector of claim 1, wherein the cover forms an aperture extending therethrough, said aperture for receiving a complementary electrical contact into the receptacle contact.

4. The electrical connector of claim 3, wherein the aperture is formed between the angled surfaces.

5. The electrical connector of claim 1, wherein the contact is a bifurcated dual-beam contact.

6. The electrical connector of claim 1, wherein the contact comprises a pair of single beams.

7. The electrical connector of claim 1, wherein each of the base housing and the cover is molded from an electrically insulating material.

8. The electrical connector of claim 1, wherein the contact is stamped from a sheet of electrically conductive material.

9. The electrical connector of claim 1, wherein the contact is retained in the base housing.

10. An electrical connector comprising:
a base housing;
a receptacle contact inserted into the base housing, said contact having a pair of contact beams, each said contact beam having a lead-in surface for receiving an angled surface of a housing cover,
wherein the contact beams are adapted to move apart by a predetermined distance to preload the contact beams against angled surfaces of the housing cover.

11. The electrical connector of claim 10, wherein the contact beams are adapted to cam outwardly in response to motion of the cover toward the base.

12. An electrical connector comprising:
a base housing;
an electrical contact inserted into the base housing, said contact having a contact beam with a lead-in surface for receiving an angled surface of a housing cover,
wherein the contact beam is adapted to move a specified distance to preload the contact beam against an angled surface of the housing cover.
